(19) United States
(12) Patent Application Publication
(10) Pub. No.: US 2003/0006931 A1
(43) Pub. Date: Jan. 9, 2003

(54) System and method for providing accurate location information for wireless or wired remote gaming activities

(76) Inventor: Ken Mages, Highland Park, IL (US)

Correspondence Address: Max Shaftal, PATZIK, FRANK & SAMOTNY, LTD., Suite 900, 150 South Wacker Drive, Chicago, IL, 60606, US

(21) Appl. No.: 10/190,056

(22) Filed: Jul. 3, 2002

Related U.S. Application Data
(60) Provisional application No. 60/302,987, filed on Jul. 3, 2001.

(51) Int. Cl. G01S 5/14; G01S 3/02

(52) U.S. Cl. 342/357.06; 342/464

(57) ABSTRACT

A system and method for accurately locating the position of wireless or wired devices used for playing casino games. The system includes a plurality of transmitters located throughout the interior of the building and on the grounds of the building property for communicating with the device. The transmitters are connected to a CDMA server or the like that is connected to a GPS base station or the like to assist in determining the precise location of the device and to verify that the device is located in an area where casino games may be lawfully played.

This application claims priority based upon U.S. Provisional Patent Application Serial No. 60/302,987 filed Jul. 3, 2001.

### FIELD OF THE INVENTION

This invention relates in general to a Global Positioning System (“GPS”), and more particularly to an Assisted Global Positioning System (“AGPS”) to accurately verify the correct geographic location of a wireless or wired device, and still more particularly to an AGPS for gaming or lottery related activities to verify the correct time and location of a user within a casino building or on casino property to ensure that the activity is legally transacted.

### BACKGROUND OF THE INVENTION

Casinos provide a venue for people to participate in gaming activities. As an incentive to encourage casino patrons who wager larger amounts of money to return to the casinos, casinos often monitor the activities of the casino patrons and provide rewards or perks (sometimes known in the industry as “comps”) based on the level of wagering activity of the patrons. Comps may include free meals, discounted or free stays at the casino hotel, tickets to various entertainment shows and the like. In addition to knowing the amount of money a particular patron spends (or at least wagers), it is also beneficial for the casino to know how the patron spends his or her time when at the casino. In particular, a patron who is receiving a free room is expected to spend a good deal of time wagering at the gaming tables. Collecting information (i.e., mining data) on how patrons spend their time while in the casino or on casino grounds allows for the casino to use that information to better direct its services and activities to the particular patron.

Recently, there has been a push for casinos to provide services to enable their patrons to remotely participate in gaming activities. Therefore, instead of having to physically sit down at a table or machine, the patron may participate in gaming activities from other locations such as a golf course. However, various laws limit the areas where gambling activity may legally take place. In particular, the Las Vegas Gaming Commission currently does not allow off-site casino gambling. Therefore, there is a need to be able to determine the exact location of an individual to ensure that it is legal for that individual to participate in the gaming activity.

Heretofore, it has been known to use GPS systems that incorporate gpsOne™ position location technology in connection with wireless devices such as cellular telephones to estimate the location of the user of the wireless device. GPS enables the tracking of objects on the surface of the earth through the use of satellites. The GPS orbiting satellites each contain transmitters that send out radio frequency signals. GPS uses a pseudo-random data stream encoded on each satellite's carrier frequency. The receiver is synchronized with the data stream by matching an identical pseudo-random data stream with a time offset. The time offset between the receiver's data stream and the data stream received from the satellite give the distance to that satellite that the radio signal traveled at the speed of light. The receiver then triangulates its position using three or more satellites and by knowing where the satellites are by way of their particular data.

Stated another way, a GPS receiver receives tracking information from various GPS satellites via a GPS antenna. The information is transmitted in digital form from the receiver to the microprocessor that then calculates, among other things, the object's latitude, longitude, heading, velocity, time and, if possible, elevation. The data can be processed and formatted as a data packet and immediately displayed, transmitted or stored in EPROM until requested.

GpsOne™ is a hybrid technology that combines information from GPS satellites and code division multiple access (CDMA) cellular/personal communication services (PCS) networks in order to locate the wireless handset being used. GpsOne™ supplements conventional GPS measurement with location measurement from CDMA base stations which are part of a network to provide positioning coverage in places where conventional GPS accuracy is insufficient. The gpsOne™ system uses satellite signals and information from cell base stations to determine the location information. A base station, or cell site, is comprised of antennas and associated electronic equipment which is usually located at a site away from buildings, or if regulations permit, on top of the buildings. Based on the signal sent from the cell base stations to the gpsOne™ receiver, the receiver “guestimates” the location of the user.

While the GPS systems using gpsOne™ technologies are an improvement over the prior GPS systems, problems have arisen in accurately determining the location of individuals inside buildings. In particular, because the signals must travel through walls and the like, the signals may deflect and cause “multi-pathing” errors in determining the position of the user. As a result, it can be determined that a user may be within a building, but the exact location of the user may not be precisely determined.

Additionally, it is known for wireless devices to use Bluetooth™ technology to connect a wireless device to other devices such as computers, printers and the like without the need for cables. Bluetooth™ is a protocol for the wireless transmission of voice and data between devices such as wireless telephones, computers, PDAs, printers and the like. In particular, Bluetooth™ technology utilizes transmitters and receivers operating in the 2.4 GHz range and frequency hopping techniques to wireless transmit voice and data.

Therefore, there is a need to produce a GPS system that accurately locates individuals on casino property while being economical and easy to manufacture and install.

### SUMMARY OF THE INVENTION

The present invention is an improvement over the prior GPS systems in that the way that an individual's location is determined is unique and an improvement over the prior art. In particular, the AGPS of the present invention includes a CDMA network server or the like that is connected to a plurality of Bluetooth™ transmitters located throughout the interior of the building and on the adjacent property. Using a casino as an example, the transmitters may be located at gaming or restaurant tables, in guest suites, on golf courses and the like. The CDMA server is in turn connected to the GPS base station and associated antenna for communicating with one or more GPS satellites. The system thereby allows for the location of a wireless device to be determined as it passes by the various transmitters. The system also may be used to determine the location of a wired device. Determining the location of the device enables the casino to establish whether the device is located within an area where gaming activities are allowed or legal. The system also permits casinos to monitor and record information including the time and money spent on a particular machine to allow the casino to locate the device and provide rewards or incentives based on the level of play.

Once it is determined that the device is located in an area where gaming activities may take place, the device connects to the Internet or a server associated with the casino to allow gaming activities to be played on the device. A smart card or biometrics having a unique identification number may be used to access the device and store information such as credit lines and winnings and losses. Recognition means may also be employed on the device to prohibit the unauthorized use of the device. Upon completion of the gaming activity, the system allows for additional games to be played provided the device remains in an area where gaming activities are lawful.

It is therefore an object of the present invention to provide a new and improved AGPS that accurately verifies the correct time and geographic location of a user of a wireless or wired device within a building or outside.

A further object of the present invention is to provide extended customer service opportunities to patrons using a wireless or wired device.

Another object of the present invention is to provide an AGPS that allows patrons of a casino to remotely participate in gaming opportunities.

A still further object of the present invention is to provide an AGPS that authenticates wireless or wired transactions to allow for gaming or lottery-related activities to be legally transacted from a wireless or wired device.

A still yet further object of the present invention is to provide an AGPS that may be used by casinos to acquire statistical information about the activities of its patrons.

A still further object of the present invention is to provide an AGPS that is easy and economical to manufacture for wired or wireless gaming devices.

Other objects, features and advantages of the invention will be apparent from the following detailed disclosure, taken in conjunction with the accompanying sheets of drawings, wherein like reference numerals refer to like parts.

### BRIEF DESCRIPTION OF THE DRAWINGS

FIG. 1 is a block diagram illustrating an embodiment of the invention showing a device operably connected to the Internet and a plurality of transmitters which in turn are operably connected to a CDMA server within a building and a GPS base station and associated GPS antenna outside the building.

FIG. 2 is a schematic view of an embodiment of a wireless device of present invention;

FIG. 3 is a vertical plan view of an embodiment of a wireless device of the present invention illustrating the display area of the wireless device including a list of possible gaming activities to play.

FIG. 4 is a vertical plan view of a wireless device showing a plurality of cards for playing video poker.

FIG. 5 is a vertical plan view of the back side of a wireless device showing a biometric thumb print scanner.

FIG. 6 is a vertical plan view of a wireless device that illustrates an error message stating that gaming activities are not allowed in the current location.

FIG. 7 is a vertical plan view of a wireless device indicating the results of a gaming activity.

FIG. 8 is a vertical plan view of a wireless device illustrating a prompt for playing another game.

FIG. 9 is a flow chart diagram of the steps involved in verifying and playing a gaming activity from a wireless device.

### DETAILED DESCRIPTION OF THE INVENTION

While this invention is susceptible of embodiment in many different forms, there is shown in the drawings and will herein be described in detail several specific embodiments, with the understanding that the present disclosure is to be considered merely an exemplification of the principles of the invention and the application is limited only to the appended claims.

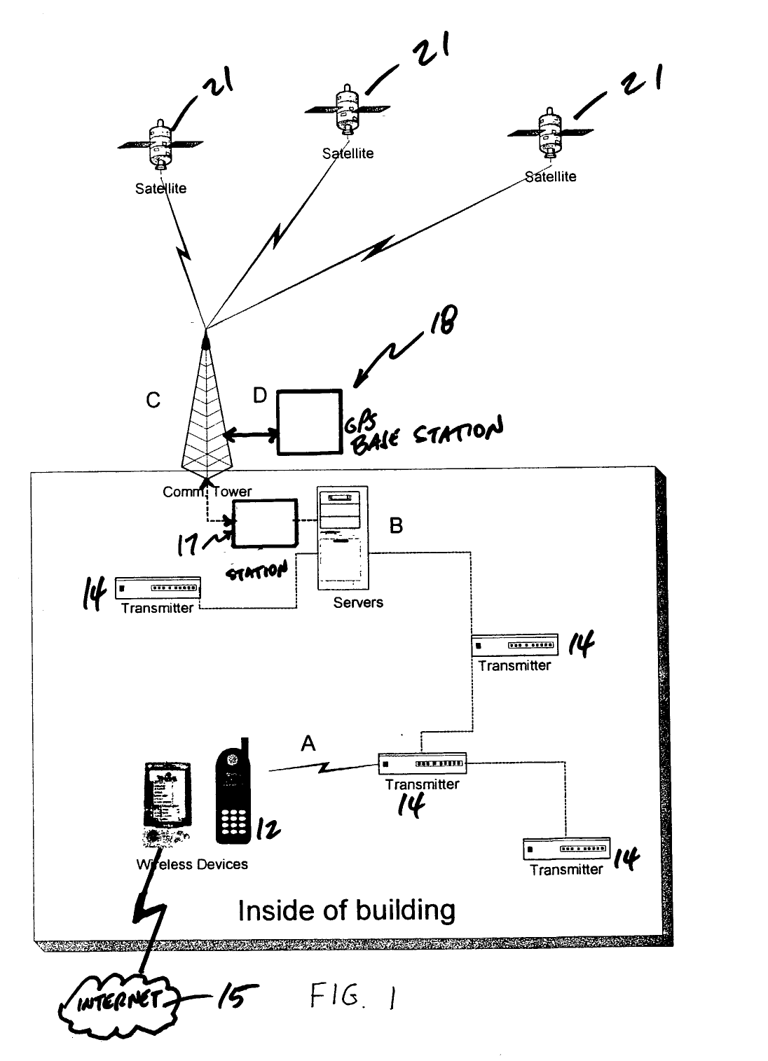

Referring now to the drawings, and particularly to FIG. 1, there is shown a preferred embodiment of the present invention. The AGPS, generally designated by the number 10, is shown as having a device module 12 operably connected to a plurality of transmitters 14 located throughout the inside of a building 16 to accurately determine the location of the device 12. Information collected from the device may then be transmitted to a microbase transceiver station 17, which in turn transmits the information to a GPS base station 18 having GPS base station circuitry and a GPS antenna 20 for transmitting and/or receiving the information or other transmissions to or from one of a plurality of GPS satellites 21 orbiting the earth. While GPS is referred to herein as the method for locating the user in the preferred embodiment, other location methods or triangulation-based technology should be considered as being within the scope of this invention. The device is also preferably connected to the Internet 15 or a server associated with a casino to enable the device to offer gaming activities. While the transmitters are shown as being located within the interior of a building, it is appreciated that they also may be located outside the building as well, so as to assist in determining the location of the device outside. It is also appreciated that the transmitters may transmit the information directly to the device, which in turn transmits the information to the GPS base station.

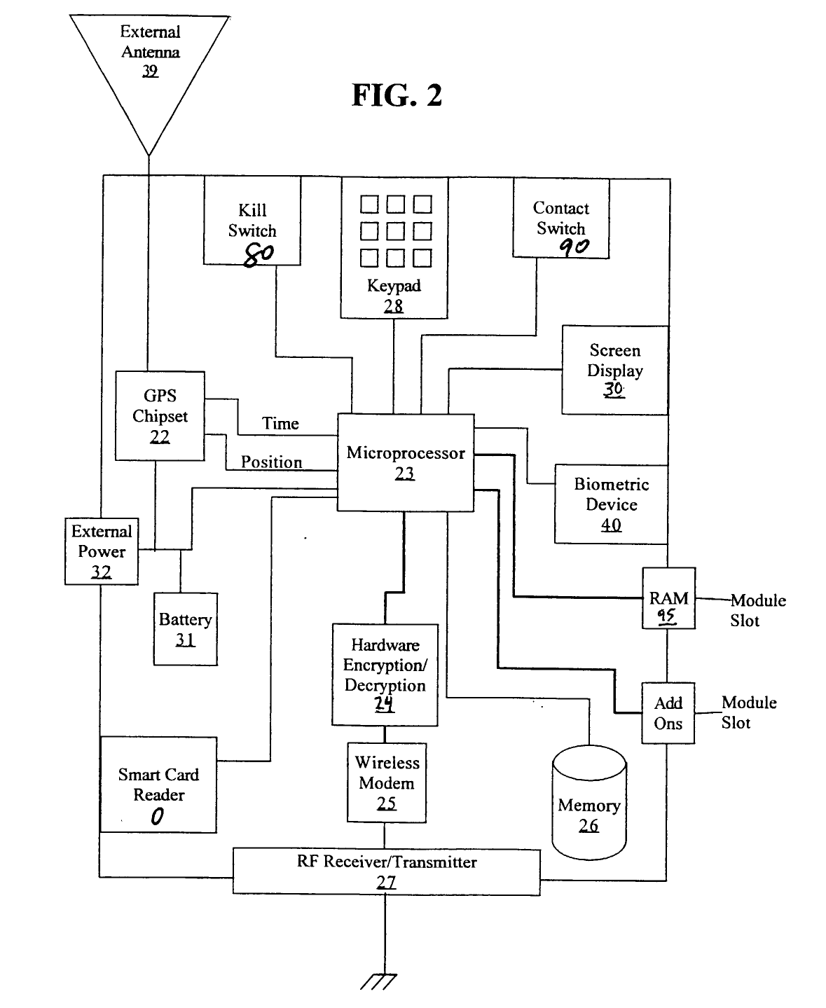

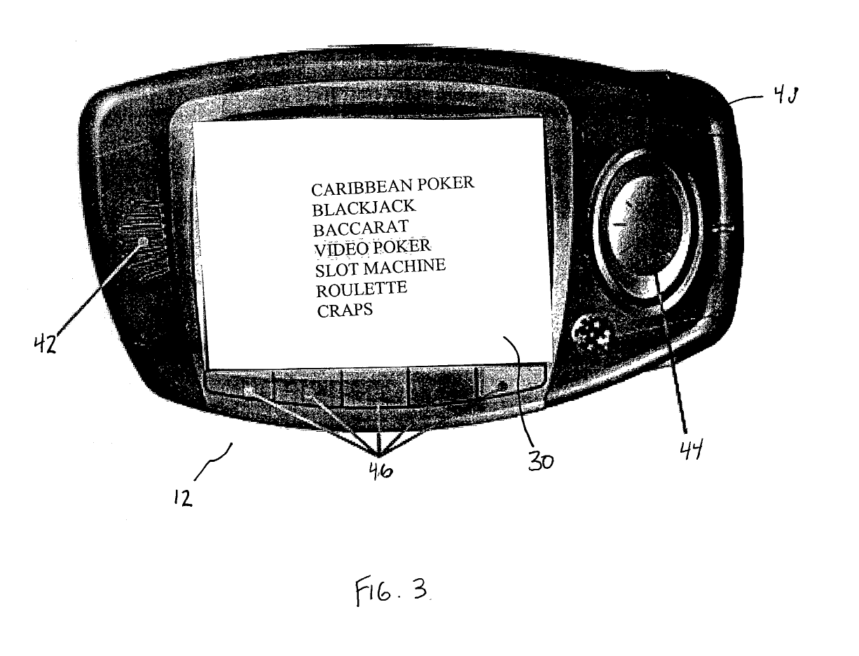

Referring now to FIGS. 2 and 3, a wireless device module for use in the present invention is shown. As shown in FIG. 2, the wireless device 12 may include GPS chipset 22 for providing time and geographic position data to microprocessor 23, means for providing hardware encryption and decryption of all information sent or received 24 from wireless device 12, wireless modem 25 or other means for connecting to the Internet 15, remote server or the like. Wireless device 12 is also provided with memory 26, RF or IR receiver/transmitter 27, keypad or screen for manually inputting data 28 and display screen 30.

Alternatively, display screen 30 can be a touch screen that serves as both the keypad for inputting information and the display screen. Keypad 28 can also be a peripheral device such as an external keyboard or a series of buttons 46 and a multidirectional thumb pad 44. Likewise, hardware encryption/decryption can be provided by the GPS chipset 22. Also provided are an external GPS antenna 39 and a receiver/transmitter antenna 38. The GPS chipset 22, kill switch 80, keypad 28, contact switch 90, screen display 30, biometric device 40, ram module slot 95, memory 26, external power 32 and battery 31 and RF receiver/transmitter are all connected to microprocessor 23. It also is appreciated that the wireless device may include any other components known in the art to allow a wireless device to send, retrieve and display information to participate in wireless gaming activities.

The wireless device 12 is sized so that it may be readily transported throughout the casino building 16. A smart or swipe card reader 50 having a unique identification number is preferably used in conjunction with the wireless device to allow the wireless device to be selectively activated and used on different occasions. For example, the smart card may be inserted into a smart card reader 50 on the side of the wireless device in a known way to allow the wireless device to access the information on the smart card. Once a smart card is issued and inserted into the wireless device 12, the wireless device communicates with the Internet 15 to allow for secure, legal wagers to be placed from within the casino or on the casino grounds. While a module wireless device is shown, it is appreciated that the device may be a cellular phone, a wireless device having cellular phone capabilities, other wireless devices such as PDAs and the like, or a wired gaming device.

As shown in FIG. 2, the wireless device 12 includes the viewing or display screen 30, such as an LCD screen, for displaying information; one or more speakers 42 for providing voice or sound in conjunction with the selections or results; and a multidirectional thumb pad 44 and a series of button 46 on the face 48 of the wireless device 12 for selecting and playing the various gaming activities or games associated with the wireless device.

In order to utilize the wireless device to place wagers within the casino, registration information is first collected and inputted into the system. Registration information, which also is preferably stored on the smart card, may include, but is not limited to, personal contact information, the credit line associated with the unique identification number, the starting and/or the remaining balance of the account associated with the unique identification number, and any frequent player reward information. While a smart card preferably stores and transmits the registration information, it is appreciated that the registration information may be linked to the wireless device in other ways, such as through passwords and the like. Once registration is complete, the smart card that contains a unique identification number and particular registration information may be used to activate the wireless device.

The wireless device preferably has GPS capabilities to work in cooperation with a GPS receiver of a GPS base station to determine the relative location of the wireless device by receiving and interpreting the signals of the GPS satellites. An example of a wireless device having GPS capabilities is a wireless device having a gpsOne chip set 22 installed. In addition to GPS capabilities, the wireless device preferably includes means to allow the wireless device to connect to the Internet or a server associated with the casino to participate in gaming activities. Connecting to the Internet or a casino server may be accomplished in a known way using the IEEE802.11 wireless LAN standard, WAP phones or other known means.

In order to log into the system, the smart card is inserted into a smart card reader 50 of the wireless device 12. If the server recognizes the unique identification number on the smart card, the main menu screen on the wireless device may be accessed from the Internet or a server. As shown in FIG. 3, the main menu screen provides a choice of several different games to play, such as video poker, blackjack and roulette. Selection of the desired game may be accomplished by scrolling through the games using the directional thumb pad 44. As described in more detail below, FIGS. 3 through 8 show an embodiment of displays associated with playing a wireless game. It is appreciated that the screens illustrated in these figures are for illustrative purposes and are not intended to limit the present invention to these particular screen displays. Once the desired game is highlighted, such as video poker, the directional thumb pad 44 or one of the series of buttons 46 may be depressed to select the game.

Before starting the game, the wireless device will prompt for a specific wager to be inputted. After the amount of the wager is inputted, the wireless device will access the stored credit line associated with the unique identification number and either accept or reject the transaction. If the wager is accepted, the game may be played. If the wager exceeds the available credit line associated with the unique identification number, the wireless device will prompt for another wager amount or display a message to see the management.

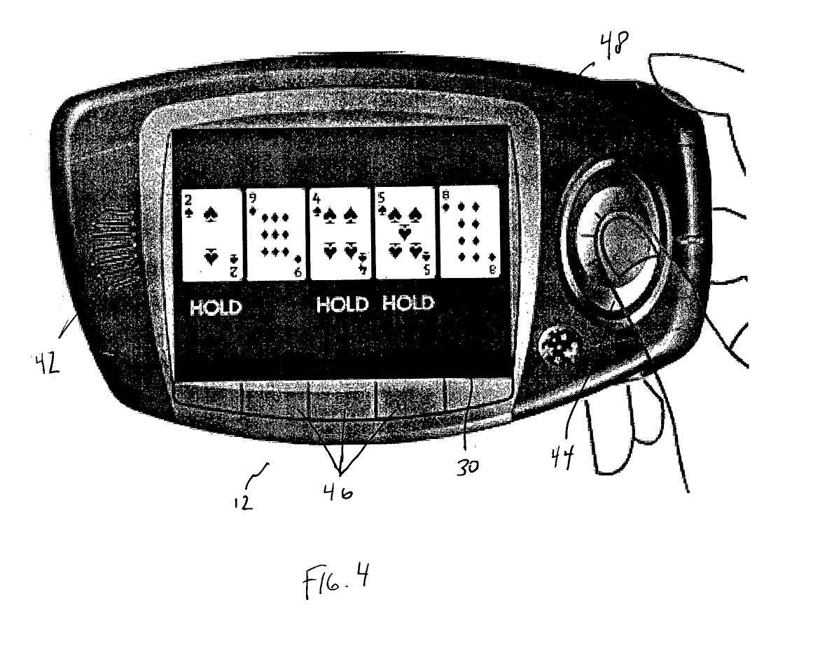

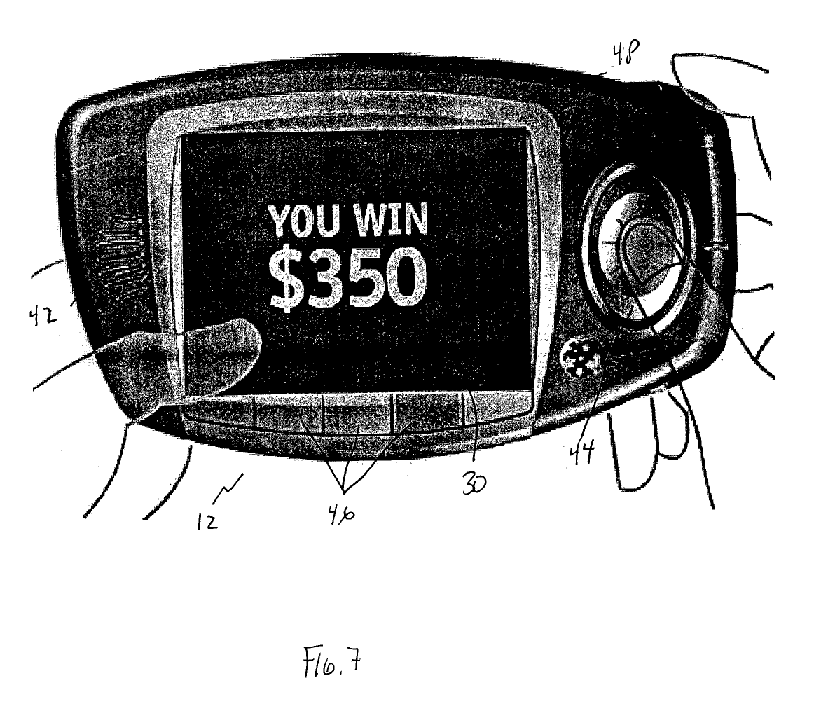

During the playing of the game, the series of buttons 46 may be used to input information or choices to play the games. Referring to the LCD screen 30 shown in FIG. 4 displaying a hand (i.e., a series of five cards) in video poker, each of the buttons 46 may be associated with a particular card to hold or discard the particular card. As shown in FIG. 7, the wireless device will display the results of the game after the game is over. Depending on the outcome of the game, the account associated with the unique identification number will be adjusted accordingly. Additional games may then be played.

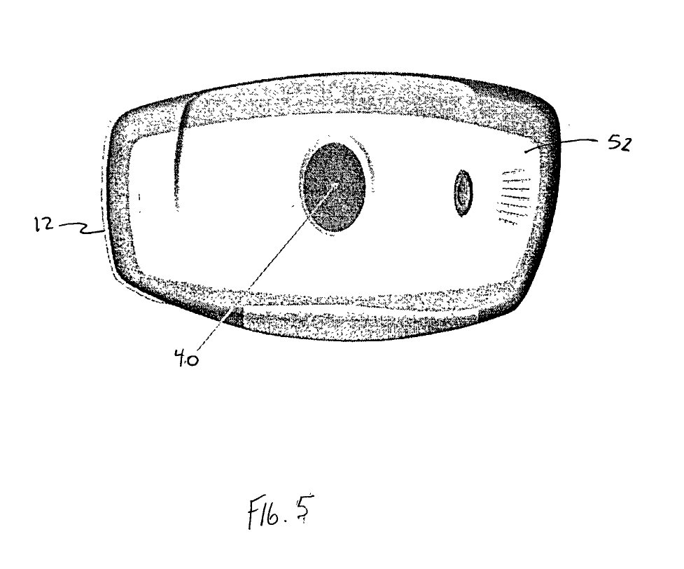

In order to ensure that the wireless device is lawfully used, the wireless device preferably includes recognition technology associated with the wireless device. As shown in FIG. 5, the wireless device includes a biometric thumb print scanner 40 on the back 52 of the wireless device 12 that compares a thumb print with an image of a thumb print that is preferably stored on the smart card. While a biometric scanner is preferred, it is appreciated that voice recognition software, alphanumeric passwords or other security mechanisms also may be used.

In addition to allowing games to be played throughout the casino and on other casino property such as at a golf course or pool-side, the wireless device 12 also communicates with a plurality of wireless transmitters 14 located throughout the interior of the casino building 16 or situated outside on the casino property to allow for the wireless device's position to be accurately determined. While it is appreciated that the transmitters and wireless device may transmit information using a variety of standards such as IEEE802.11, it is preferred that they operate using Bluetooth. In order to determine the location of the wireless device, each Bluetooth transmitter includes its own unique identifier and is pre-programmed based on its location inside the building. Thus, when the information stored on the transmitters is combined with the general location information provided by the GPS, the wireless device's precise location may be determined.

Currently, the transmitters operate most effectively over a shorter distance of about 10 to 30 feet. Therefore, it is preferred that the transmitters be located throughout the interior and outside of the building so that the effective range of the transmitters substantially covers the entire interior of the building and outside property. However, it is appreciated that a lesser number of transmitters may be employed and not depart from the scope of the present invention.

As the wireless device moves through the casino or on the casino grounds and passes from one transmitter to the second transmitter, the wireless device begins communicating with the second transmitter to indicate the wireless device's movement inside or outside the casino. This is commonly known as “handing off” the signal from one transmitter to another transmitter. As the wireless device moves further away from the first transmitter and outside the predetermined range of the transmitter, the wireless device will cease communicating with the first transmitter. The second transmitter will then communicate with the server to indicate the new location of the wireless device.

The transmitters may also be set to monitor the activity of specific machines or tables by adjusting the range of the transmitters. For example, a casino may place a transmitter on every slot machine and adjust the range to one or two feet to monitor the activity associated with a particular machine. The casinos may then monitor how long a particular game is played and how much money is wagered for its records to assist in providing various services.

The microbase transceiver station 17 is preferably a CDMA server, although it is appreciated that it may be other types of servers or transceiver stations and not depart from the scope of the present invention. Connecting to a CDMA server 17 allows for services associated with the CDMA server to be available for use with the wireless device. Such services include the transmission of voice and data to and from the wireless device. While a CDMA server is preferably used to allow the user of the wireless device to send and receive information, it is appreciated that the transmitters may send the information directly to the GPS base station 18 and GPS satellites 21 to determine the location of the wireless device. The transmitters also may send the information directly to the wireless device, which in turn sends the information to the GPS base station and GPS satellites.

In addition to providing wireless gaming activities, the wireless device also may provide extended customer service opportunities. Extended customer service opportunities may include, but are not limited to, making and checking reservations for dinner and entertainment shows; checking a room bill; making future room reservations; watching preview of the shows and the like.

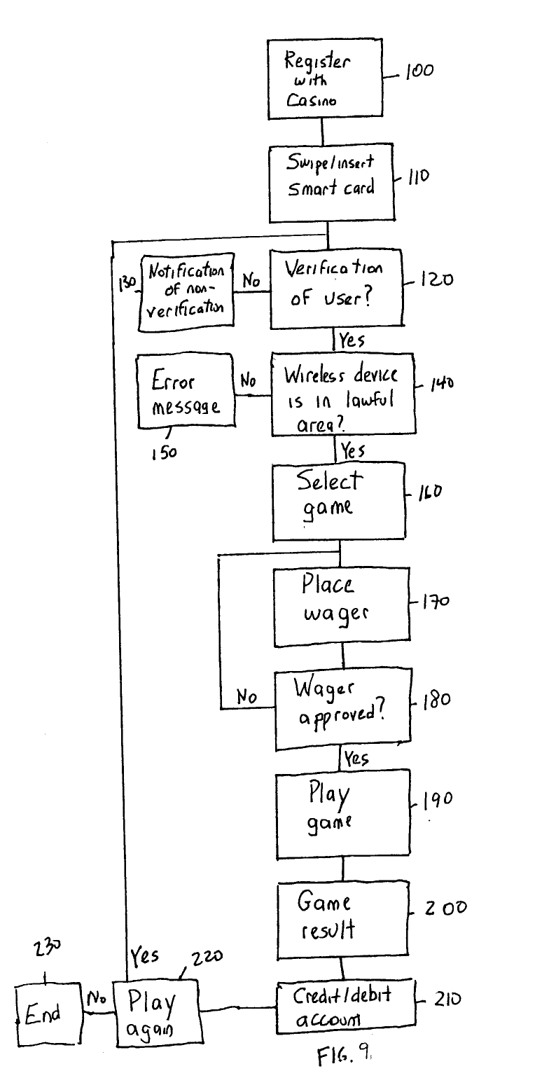

Referring to FIG. 9, the preferred steps in wirelessly playing a game are shown. In order to use a wireless device 12, a smart or swipe card is obtained from the casino in step 100 that includes a unique identification number. The unique identification number allows the casino to, among other things, check the credit line associated with the unique identification number. The smart card may then be inserted into a smart card reader 50 of the wireless device 12. Once the unique identification number is received and validated by the casino, the wireless device may prompt for verification of the authorization to use the wireless device in step 120 through the use of a biometric thumb print scanner 40 or password. If the authorization process is not satisfied, the wireless device will display a message indicating that the identification was not validated. The wireless device may then prompt for an additional attempt at verification in step 130 or transmit a message to the casino indicating the potential unauthorized use of the wireless device to allow the casino to investigate the matter.

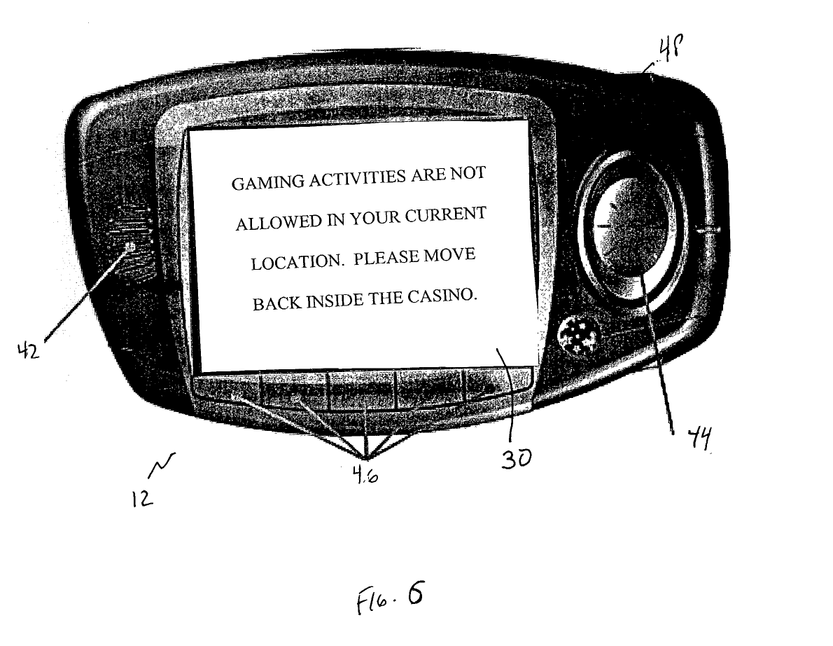

Upon completion of the authorization process, the wireless device 12 communicates with one or more transmitters 14 located throughout the casino resort area and a GPS base station 18 and satellites 21 in step 140 to determine the location of the wireless device. If it is determined that the wireless device is located in an area where gaming activity is not permitted, then the wireless device, as shown in FIG. 6, will display an error message in step 150 indicating that the wireless device is currently located in an area where participation in gaming activity is prohibited. Using the transmitters to determine the location of the wireless device, the system may then provide directions to the wireless device indicating where to proceed within the casino to play the game. While the location of the wireless device is shown as being accomplished after the authorization step, it is appreciated that the step may be performed at different stages through the gaming process to determine the location of the wireless device.

If it is determined that the wireless device is in an area where gaming activity is allowed, the wireless device will connect to the Internet or a server associated with the casino in a known way to display a series of possible games to play. After a game is selected to play in step 160, the wireless device prompts for a wager amount to be entered in step 170. Before proceeding with the game, the credit line associated with the unique identification number used in the wireless device is checked in step 180 to determine if the wager amount is approved. If the wager amount exceeds the authorized limit, then the wireless device will prompt for another wager amount to be entered in step 170.

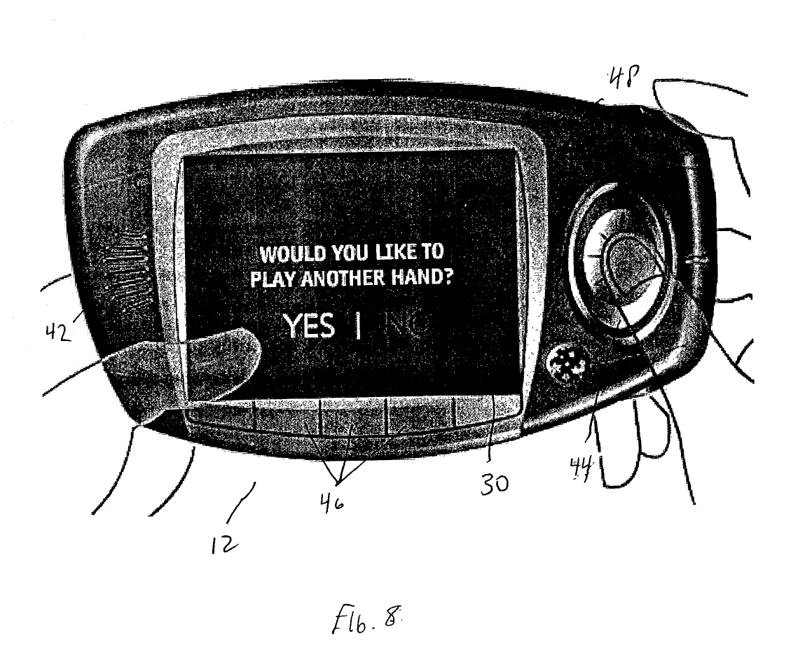

If the wager amount is approved, the game is played in step 190. Upon completion of the game, the results, as shown in FIG. 7, are displayed in step 200 and the account associated with the unique identification number is credited or debited accordingly in step 210. As shown in FIG. 8, the wireless device then asks whether another game is to be played in step 220. If another game is not desired, then the wireless device will terminate the connection to the Internet or server to end the gaming activities in step 230. On the other hand, if another game is desired, it is preferred that the above process be repeated starting with verifying the identity in step 120. While it is preferred that the identity be verified before playing each game, it is appreciated that the verification step may only be performed once or at preset intervals during use of the wireless device.

It will be understood that modifications and variations may be effected without departing from the scope of the novel concepts of the present invention, but it is understood that this application is limited only by the scope of the appended claims.

1. A system for locating the user of a device inside or outside a building comprising;
a GPS base station, wherein the GPS base station communicates with at least one GPS satellite;
a plurality of transmitters located inside or outside the building, wherein each of the plurality of transmitters is programmed to transmit information concerning its location; and
a device operably connected to the plurality of transmitters for providing the location of the user of the device inside or outside the building.

2. The system of claim 1 wherein the device is a wireless device.

3. The system of claim 2 which further comprises means to provide extended customer service opportunities.

4. The system of claim 2 which further comprises a CDMA network including a server for permitting the wireless device to offer cellular services.

5. A system for verifying the location of a user of a device who desires to participate in gaming activities comprising:
a GPS base station, wherein the GPS base station communicates with at least one GPS satellite;
a plurality of transmitters located inside the building and operably connected to the GPS base station; and
a device operably connected to the plurality of transmitters for providing the location of the user of the device within the building; and
means to provide gaming activities.

6. The system of claim 5 wherein the device is a wireless device.

7. The system of claim 6 wherein the plurality of transmitters are Bluetooth transmitters.

8. The system of claim 6 which further comprises means to recognize the identity of the user.

9. The system of claim 8 wherein the recognizing means includes a biometric thumb print scanner.

10. The system of claim 8 wherein the recognizing means includes an alphanumeric password.

11. The system of claim 6 which further comprises means to record information associated with the wireless device.

12. The system of claim 11 wherein the recorded information includes the duration of time spent playing a game and the amount of money wagered.

13. The system of claim 6 wherein the means to play gaming activities includes connecting the wireless device to the Internet.

14. The system of claim 6 wherein the means to play gaming activities includes connecting the wireless device to a remote server.

15. The system of claim 6 which further includes a plurality of transmitters located outside the building.

16. The system of claim 6 which further includes a CDMA network having a server to allow the wireless device to participate in cellular services.

17. A method for locating the user of a device inside a building comprising the steps of:
providing a device having GPS capabilities for communicating with at least one GPS satellite and a GPS base station;
receiving at least one signal from at least one GPS satellite at the device;
receiving at least one signal from one of a plurality of transmitters located inside the building at the device, wherein the one of a plurality of transmitters includes information regarding the location of the transmitter; and
transmitting the information regarding the location of the transmitter that is in communication with the device to the GPS base station or GPS satellite to assist in accurately determining the location of the device.

18. The method of claim 17 wherein the device is a wireless device.

19. The method of claim 17 wherein the plurality of transmitters are Bluetooth transmitters.

20. A method for verifying the location of a user of a device for participating in gaming activities associated with a casino, the method comprising the steps of:
providing a device for participating in gaming activities;
providing means to activate the device;
determining the location of the device;
selectively allowing the gaming activities to proceed depending on the location of the device.

21. The method of claim 20 wherein the device is a wireless device.

22. The method of claim 21 wherein the step of determining the location of the wireless device comprises:
a GPS base station, wherein the GPS base station communicates with at least one GPS satellite; and
a plurality of transmitters located inside the building, wherein each of the plurality of transmitters is programmed to transmit information concerning its location in the building;
wherein, the wireless device is operably connected to the plurality of transmitters for providing the location of the user of the wireless device within the building.

23. The method of claim 21 wherein the means to activate the wireless device includes a smart card having a unique identification number.

24. A method for participating in gaming activities within the boundaries of a property comprising the steps of:
providing a device for participating in gaming activities;
connecting the device to the Internet or a computer system of the casino;
providing means to activate the device;
determining the location of the device by using transmitters positioned on the property;
selectively allowing the gaming activities to proceed depending on the location of the device.

25. The method of claim 24 wherein the device is a wireless device.

26. The method of claim 25 which further includes the step of verifying the identity of the user.

27. The method of claim 25 wherein the step of verifying the identity of the user includes a biometric thumb print scanner.

28. The method of claim 25 wherein the step of verifying the identity of the user includes the step of inputting an alphanumeric password.

29. The method of claim 25 wherein the system further includes the step of recording information associated with the use of the wireless device.

30. The method of claim 29 wherein the information includes the duration of time spent playing a game and the amount wagered.

31. The method of claim 25 wherein the step of determining the location of the wireless device comprises:
a GPS base station, wherein the GPS base station communicates with at least one GPS satellite; and
a plurality of transmitters located inside the building, wherein each of the plurality of transmitters is programmed to transmit information concerning its location in the building;
wherein, the wireless device is operably connected to the plurality of transmitters for providing the location of the user of the wireless device within the building.

32. The method of claim 31 which further comprises a second plurality of transmitters located outside the building, wherein each of the second plurality of transmitters is programmed to transmit information concerning its location outside the building and wherein the wireless device is operably connected to the second plurality of transmitters for providing the location of the user of the wireless device outside the building.

33. The method of claim 25 wherein the means to activate the wireless device includes a smart card having a unique identification number.

34. A method for allowing a device user having an account to participate in gaming activities on a property comprising the steps of:
providing a device for participating in gaming activities;
connecting the device to the Internet or a computer system of the casino;
providing means to activate the device;
determining the location of the device by using a plurality of transmitters located on the property;
selectively allowing the gaming activities to proceed depending on the location of the device;
offering at least one gaming activity to be played on the device;
indicating the results of the gaming activity;
adjusting the account of the device user based on the results of the gaming activity; and
prompting the user to inquire if the user wants to play again.

35. The method of claim 34 wherein the device is a wireless device
